(19) United States
(12) Patent Application Publication
(10) Pub. No.: US 2010/0230193 A1
(43) Pub. Date: Sep. 16, 2010

(54) PLUG-IN VEHICLE FUNCTION INDICATION

(75) Inventors: Duane M. Grider, Farmington Hills, MI (US); Daniel William Forthoffer, Grosse Pointe Woods, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD GLOBAL TECHNOLOGIES, LLC, Dearborn, MI (US)

(21) Appl. No.: 12/403,022

(22) Filed: Mar. 12, 2009

(51) Int. Cl. B60W 10/30; B60R 13/02; B60W 20/00; B60Q 1/00

(52) U.S. Cl. 180/65.27; 296/1.08; 340/455; 340/438; 903/952

(57) ABSTRACT

A vehicle having a vehicle body has an interior portion with a plurality of trim components. A plurality of windows are supported on the body and positioned next to the interior portion. An electrical charging system having a rechargeable battery is attached to the vehicle body and configured to receive an electrical charge from at least one of an on-board charger, an external charger or a charging station. A display panel is connected to the electrical charging system and mounted on one of the trim components. The display panel is configured to display information indicative of a status of the electrical charging system. The display panel is disposed in a position such that the information is visible from a position exterior to the vehicle body.

### BACKGROUND

1. Technical Field

Embodiments of the present invention relate to the provision of information about the status of an electronic charging system for a plug-in hybrid electric vehicle while the electric charging system is plugged in to receive a charge.

2. Background Art

Plug-in vehicles such as plug-in hybrid electric vehicles and electric vehicles include an electric charging system that has a rechargeable battery. The electric charging system and rechargeable battery of such a vehicle is configured to, among other things, be configured to receive a charge from a standard electrical outlet of a household. If an operator of such a vehicle plugs the electric charging system of the vehicle into an electric outlet, but the vehicle lacks the ability to provide feedback to the user regarding the status of the electric charging system, the user may remain unaware of important information about the electric charging system that may be needed to ensure that the electric charging activities undertaken by the user is/are/were successful. The present invention addresses this and other problems.

### SUMMARY

Various embodiments of a vehicle configured to receive an electric charge from a power source positioned external to the vehicle are disclosed herein. In a first embodiment, the vehicle comprises a vehicle body having an interior portion that is partially defined by a plurality of windows. The interior portion also includes a plurality of trim components therein. The vehicle further comprises an electrical charging system within the vehicle body. The electrical charging system is configured to receive an electrical charge from an external source. The vehicle further comprises a display panel that is connected to the electrical charging system to display a status thereof. The display panel is mounted on a trim component in a position such that the information displayed thereby is visible from a position exterior to the vehicle body.

In an implementation of the first embodiment, the display panel may be mounted on a trim component covering a portion of an A-pillar of the vehicle body.

In another implementation of the first embodiment, the display panel may be mounted proximate one of the plurality of windows.

In another implementation of the first embodiment, the display panel may be mounted on a package shelf in a variation of this implementation, the display panel may be mounted proximate a rear window.

In another implementation of the first embodiment, the display panel may be further configured to display information corresponding to a state of charge of the rechargeable battery.

In another implementation of the first embodiment, the display panel may be further configured to display information corresponding to an amount of time remaining until charge completion for the rechargeable battery.

In another implementation of the first embodiment, the display panel may be further configured to display information indicative of an on-plug status of the electrical charging system. In a variation of this implementation, the display panel may be further configured to display information indicative of a fault experienced by the electrical charging system while on-plug.

In another implementation of the first embodiment, the display panel includes a means for displaying the information indicative of the status of the electrical charging system.

In another implementation of the first embodiment, the display panel may be further configured to display the information for a predetermined period of time. In a variation of this implementation, the display panel may be further configured to display the information in response to one of the electrical charging system beginning to receive an electrical charge and a latch on a door to the vehicle body being actuated.

In another implementation of the first embodiment, the display panel may be further configured to emit an audible signal indicative of a status of the electrical charging system. In a variation of this implementation, the audible signal may comprise a first tone that is indicative of the electrical charging system receiving an electrical charge while the electrical charging system is on-plug. In a further variation, the audible signal may comprise a second tone indicative of a fault experienced by the electrical charging system when the electrical charging system is on-plug.

In another implementation of the first embodiment, the display panel is further configured to receive customer inputs and to display information indicative of a charge mode initiated by the vehicle operator or a connected electrical utility.

In another implementation of the first embodiment, the vehicle body may further include a light sensor that is configured to detect when ambient light diminishes below a predetermined level. The display panel may be further configured to provide a first level of illumination when the ambient light is above the predetermined level. The display panel may be so further configured to provide a second level of illumination when the ambient light is below the predetermined level.

In another implementation of the first embodiment, the display panel may include an interface portion configured to receive input from a user.

In a second embodiment, a display panel for use with a vehicle is disclosed. The vehicle has a vehicle body with an interior portion that has a plurality of trim components. The vehicle also has a plurality of windows supported on the vehicle body and disposed adjacent the interior of the vehicle body. The vehicle also has an electrical charging system attached to the vehicle body and including a rechargeable battery. The electrical charging system is configured to receive an electrical charge from at least one of an on-board charger, an external charger or a charging station. In this embodiment, the display panel comprises a panel mounted on one of the trim components. The panel is configured to display information indicative of a status of the electrical charging system. In this second embodiment, the display panel is further configured to be disposed in a position such that the information displayed by the display panel is visible from a position exterior to the vehicle body

In a third embodiment, the vehicle comprises a vehicle body having an interior portion. The interior portion has a plurality of trim components. The vehicle further comprises a plurality of windows supported on the vehicle body and disposed adjacent to the interior portion. The vehicle further comprises an electrical charging system including a rechargeable battery. The electrical charging system is attached to the vehicle body and is configured to receive an electrical charge from one or more of an on-board charger, an external charger or a charging station. The vehicle further comprises an electric motor electrically connected to the rechargeable battery. The electric motor is configured to propel the vehicle body. The vehicle further comprises an internal combustion engine mounted on the vehicle body and configured to propel the vehicle body. The vehicle further comprises a display panel that is connected to the electrical charging system and mounted on one of the trim components. The display panel is configured to display information indicative of a status of the electrical charging system. The display panel is disposed in a position such that the information displayed by the display panel is visible from a position exterior to the vehicle body.

### BRIEF DESCRIPTION OF THE DRAWINGS

The description herein makes reference to the accompanying drawings wherein like reference numerals refer to like parts throughout the several views, and in which:

FIG. 1 is a schematic view illustrating an embodiment of a vehicle made in accordance with the teachings of the present invention;

FIG. 2A is a side view of an embodiment of a vehicle made in accordance with the teachings of the present invention;

FIG. 2B is a perspective view illustrating a portion of an interior of the vehicle depicted in FIG. 2A;

FIG. 3 is a perspective view illustrating an embodiment of a display panel made in accordance with the teachings of the present invention;

FIG. 4 is a perspective view illustrating an alternate embodiment of a vehicle made in accordance with the teachings of the present invention;

FIGS. 5A and 5B illustrate an alternate embodiment of the display panel of the present invention illustrated in various illuminated and sound emitting states.

### DETAILED DESCRIPTION OF EMBODIMENTS OF THE INVENTION

Detailed embodiments of the present invention are disclosed herein; however, it is to be understood that the disclosed embodiments are merely exemplary of the invention that may be embodied in various and alternative forms. The figures are not necessarily drawn to scale, some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

Vehicles other than those propelled by traditional fuels such as gasoline and diesel fuel are entering the marketplace. Some vehicles propelled by alternative forms of energy include vehicles propelled by electric motors. Some such vehicles include rechargeable batteries to power the electric motor. Some of these vehicles are configured to receive a charge from a power source positioned external to the vehicle such as, but not limited to, a standard household electric power outlet. Furthermore, as the state of battery technology improves, it is foreseeable that rechargeable batteries may be rechargeable within a relatively short span of time when compared with the rechargeable batteries of today. For instance, it is foreseeable that a rechargeable battery capable of containing enough electrical power to propel a vehicle through its normal daily operations may, in the future, be rechargeable within a period of minutes. Thus, it is foreseeable that, in the future, there may be electric charging stations similar to the gas stations of today.

In view of the spread of vehicles propelled by electric motors that are powered by rechargeable batteries, users of such vehicles may need a way to monitor the state of charge of the rechargeable battery or of some other component of an electrical charging system associated with the vehicle while the vehicle is “on-plug”. As used herein, the term “on-plug” refers to a condition where the electrical charging system of a vehicle is plugged into an electrical power source such as, but not limited to, a standard household electrical outlet. A vehicle user recharging his vehicle may wish to be presented with information regarding the status of the electrical charging system of his vehicle such as whether the electrical system is “on-plug”, whether the rechargeable battery is being recharged, whether there is a fault in the electrical charging system that is interfering with or precluding the rechargeable battery from being recharged, and when the electric charging system will complete the recharging cycle. Further, it may also be useful for a vehicle user to be able to input information into the electrical charging system such as a desired start time or a desired completion time for electric charging.

Embodiments of the present invention provide solutions to the above-referenced problems. For example, a vehicle having an interior and a plurality of surfaces formed by trim components disposed throughout the interior of the vehicle body will include a display panel mounted on one of the trim components. The vehicle body will also include a plurality of windows disposed about the vehicle body. The display panel may be disposed on a trim component that is positioned in close proximity to one of the windows and may further be positioned such that a display screen or other display portion of the display panel is visible from a position outside the vehicle.

The vehicle body will include an electrical charging system including a rechargeable battery. The electrical charging system will be configured to receive an electrical charge from a power source positioned outside of the vehicle such as an electrical outlet located in a garage of a private dwelling. The display panel may be connected to the electrical charging system and may receive input from the electrical charging system indicative of a status of the electrical charging system.

A greater understanding of the embodiments of the present invention may be obtained through a review of the illustrations accompanying this disclosure together with a review of the detailed description contained below.

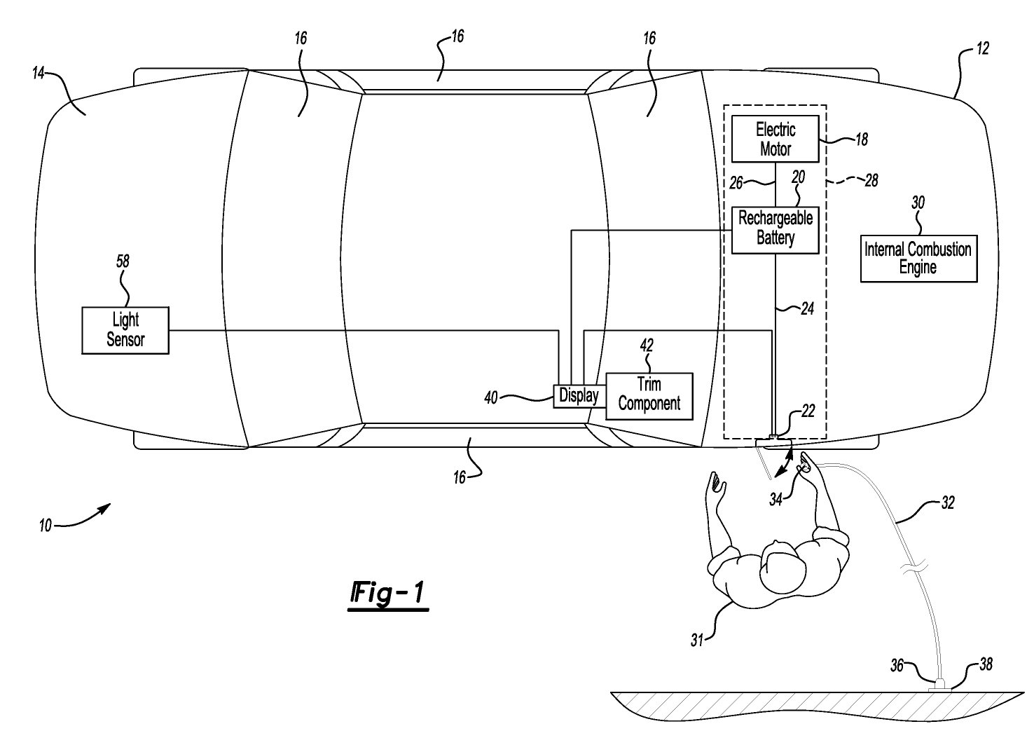

With respect to FIG. 1, a vehicle 10 is schematically illustrated inside a garage of a private dwelling. Vehicle 10 may be any type of vehicle including, but not limited to, passenger sedans, coupes, sport utility vehicles, pickup trucks, minivans, full size vans, cross over utility vehicles, motorcycles, lawn mowers, farming equipment, recreational vehicles, commercial trucks, golf carts, neighborhood electric vehicles, and busses.

Vehicle 10 includes a vehicle body 12 configured to house vehicle occupants and travel on surfaces such as roads and highways. The vehicle body has an interior portion 14 configured to house vehicle occupants. Vehicle body 12 supports windows 16 which permit occupants positioned within interior portion 14 to see out of vehicle body 12. Windows 16 may be completely transparent or, in some embodiments, may have tinting. Window 16 located at the front of vehicle body 12 is commonly referred to as the windshield while window 16 disposed at the rear of vehicle body 12 is commonly referred to as the rear windshield.

Vehicle 10 further includes an electric motor 18 mounted on vehicle body 12 and configured to deliver torque to one or more wheels connected to vehicle body 12. Rechargeable battery 20 is mounted to vehicle body 12 and is electrically connected to electric motor 18 and configured to deliver electric power to electric motor 18 to allow electric motor 18 to deliver torque to one or more of the wheels attached to vehicle body 12.

Vehicle 10 also includes a docking station 22. Docking station 22 is configured to engage and receive a plug such as, but not limited to, a receiving end or a pronged end of an extension cord compatible with a standard household electrical outlet. Docking station 22 is electrically connected to rechargeable battery 20 and is configured to deliver electricity to rechargeable battery 20 when docking station 22 is electrically connected to an external electric power source. Electric power is transmitted from docking station 22 to rechargeable battery 20 across cable 24. Electric energy is transmitted from rechargeable battery 20 to electric motor 18 across cable 26.

Electric motor 18, rechargeable battery 20, docking station 22 and cables 24 and 26 together comprise an electrical charging system 28.

In some embodiments of vehicle 10, such as the embodiment illustrated in FIG. 1, an internal combustion engine 30 is included. Internal combustion engine 30 may be mounted to vehicle body 12 and may be configured to deliver torque to one or more of the wheels of vehicle body 12. Internal combustion engine 30 and electric motor 18 may be configured to work in parallel with each other to simultaneously supply torque to one or more drive wheels including one or more of the same drive wheels. In other embodiments, internal combustion engine 30 may be configured to operate solely for the purpose of supplying an electric charge to rechargeable battery 20.

An operator of vehicle 10 may charge the electric charging system 28 and thus replenish any electric power drained from rechargeable battery 20 by connecting a recharging apparatus, such as an extension cord 32 having a plug 34 configured to engage docking station 22 into docking station 22 while an opposite end 36 is plugged into a standard household electrical outlet 38. Alternatively, opposite end 36 may be plugged into a portable on-board charger or into an outlet at a recharging station. When user 31 engages docking station 22 with plug 34, user 31 may wish to receive feedback from electrical charging system 28 such as whether plug 34 is properly engaged with docking station 22, whether rechargeable battery 20 is receiving a charge, what the state of charge is for rechargeable battery 20, what the estimated time is until recharging is completed, utility information and home energy management system information.

Display panel 40 is attached to vehicle body 12 and is configured to display information. Display panel 40 is connected to rechargeable battery 20 and may be configured to detect the state of charge of rechargeable battery 20. Display panel 40 is also connected to docking station 22 and may be configured to detect whether docking station 22 is connected to an external power source. In other embodiments of display panel 40, display panel 40 is configured to receive signals from rechargeable battery 20 relating to the state of charge of rechargeable battery 20 and signals from docking station 22 indicative of whether docking station 22 is connected to an external power source. Display panel 40 is mounted to a trim component 42 mounted within an interior portion of vehicle body 12. The trim component may be, for example, a pillar cover, a package shelf, or other vehicle trim component.

Display panel 40 is mounted to trim component 42 in a position that permits user 31 to view display panel 40 while situated outside of vehicle body 12. In some embodiments, display panel 40 will be positioned proximate one of the windows 16 and facing outwardly. In other embodiments, display panel 40 will be mounted to a trim component 42 that is disposed proximate to docking station 22 so as to be visible to a user 31 as he inserts plug 34 into docking station 22.

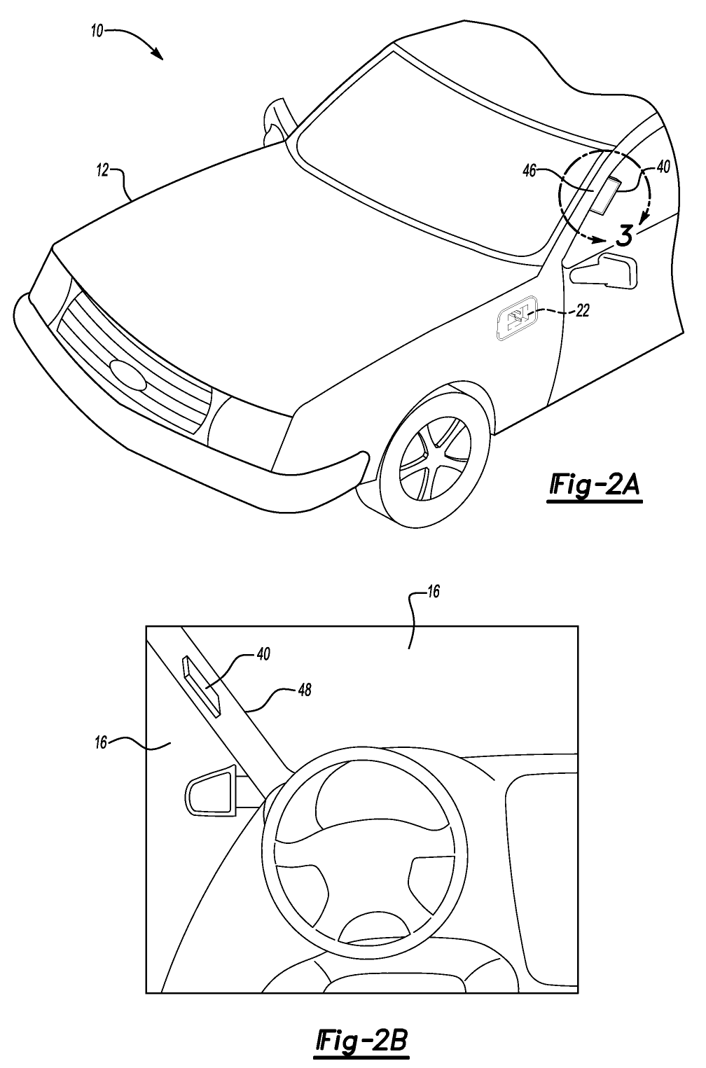

With respect to FIG. 2A, a side view of an embodiment of a vehicle made in accordance with the teachings of the present invention is illustrated. Docking station 22 is enclosed behind a door 44 to provide docking station 22 with some protection from wind, rain, snow and other elements. In this illustrate embodiment, docking station 22 is disposed on a front quarter panel of vehicle body 12. It should be understood that docking station 22 may be disposed anywhere on vehicle body 12 including front quarter panels, rear quarter panels, rear fascia behind exterior light modules, mirror assemblies, rear taillight assemblies, the front grille and in any other desirable location. Display panel 40 is mounted to a trim component 42 (not shown in FIG. 2A) covering an internal portion of A-pillar 46. Configured in this manner, a user 31 is positioned substantially directly in front of display panel 40 as he inserts plug 34 into docking station 22. Being positioned in this manner allows user 32 to quickly ascertain needed information about electrical charging system 28 when he connects plug 34 to docking station 22.

With respect to FIG. 2B, a perspective view of interior portion 14 of vehicle body 12 is presented. A portion of the windshield 16 is illustrated. A-pillar cover 48 covers a portion of A-pillar 46 (not shown) and may comprise plastic or other materials suitable for use to cover and conceal A-pillar 46. Display panel 40 is mounted to an upper portion of A-pillar cover 48 and protrudes outwardly therefrom in a direction generally parallel to the driver's side window 16. Mounted in this manner, the display portion of display panel 40 is visible from a position outside of vehicle body 12 and may or may not be visible to a user seated in interior portion 14. In some embodiments, display panel 40 may be permanently affixed to A-pillar cover 48 while in other embodiments, display panel 40 may be disposed within a recess in A-pillar cover 48 and may deploy to a visible position when electrical charging system 28 is being charged.

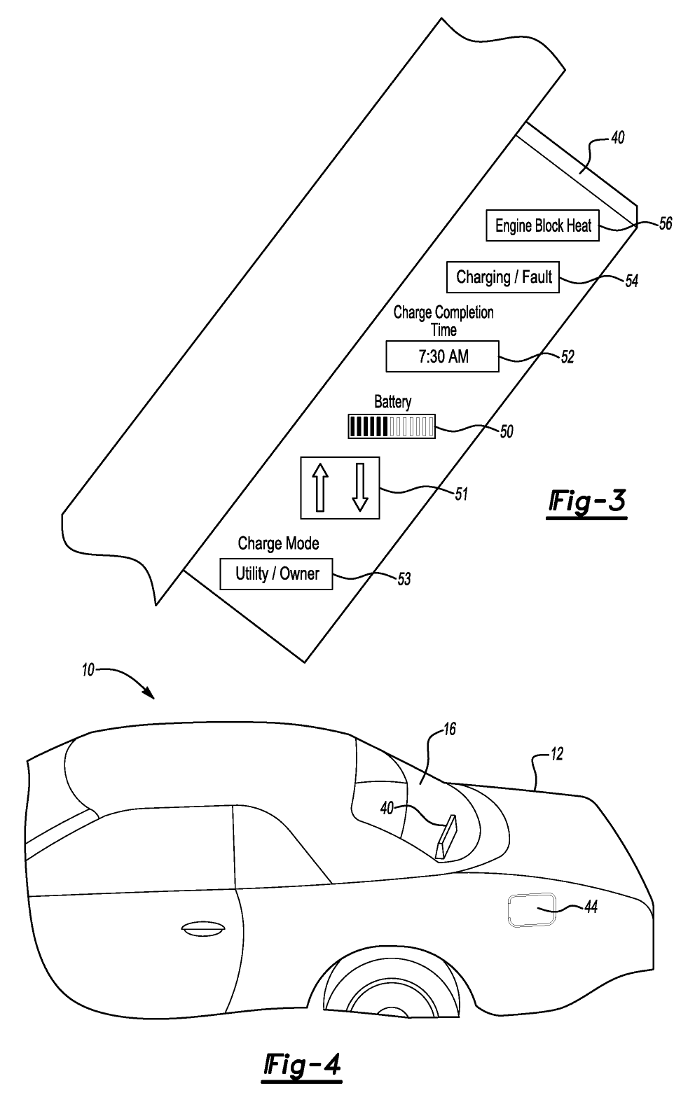

With respect to FIG. 3, a portion of A-pillar 46 circled in FIG. 2a is enlarged. FIG. 3 illustrates some of the information that may be displayed by display panel 40 including a read-out 50 depicting a state of charge for rechargeable battery 20. In the illustrated embodiment, a plurality of bars are depicted, the number of bars corresponding to a percentage of charge held by rechargeable battery 20. The higher the number of bars depicted, the greater the percentage of charge rechargeable battery 20 is holding. Display panel 40 also displays an estimated charge completion time readout 52. This allows display panel 40 to display to user 31 the estimated time when charging may be completed. In other embodiments, charge completion readout 52 may display the number of hours or minutes remaining until charge is complete.

Display panel 40 also includes a charging/fault readout 54. Charging/fault readout 54 displays an indication of whether or not electrical charging system 28 is receiving a charge from household electric outlet 38 or from some other source when docking station 22 is engaged with either plug 34 or some other charging apparatus. If rechargeable battery 20 is receiving a charge, then the charging portion of charging/fault readout 54 may be illuminated. If docking station 22 is engaged with plug 34 but no charge is being received by rechargeable battery 20, charging/fault readout 54 will indicate a fault. An engine block heater readout 56 may also be included on display panel 40 and may indicate that an engine block associated with internal combustion engine 30 is receiving current. Other readouts may include an indication of remaining battery life for rechargeable battery 20. Additionally, display panel 40 may be configured to include an input window 51 having touch screen type sensitivity or buttons or any other configuration effective to allow a user to input settings relating to a recharging cycle for rechargeable battery 20. For instance, using input window 51, a vehicle operator may be able to initiate a charge mode or set a charge mode to begin or end at a desired time or to initiate a charge mode at the discretion of a local utility company in accordance with a contractual arrangement that the vehicle operator has with the local utility company. A vehicle operator may also be able to use input window 51 to initiate or end an engine block heating cycle. Display panel 40 may further include a charge mode indicator 53 which can indicate information relating to the charge received by rechargeable battery 20 such as whether a current charge cycle has been initiated by the vehicle operator or by the local utility company. In other embodiments, display panel 40 may be configured to provide information relating to a charge enable status, a charge pause status, metered energy and price control charge.

Display panel 40 may include a variety of means to display some or all of the information items discussed above or additional informational items potentially of interest to user 31. Display 40 may include a liquid crystal display illuminated by incandescent or fluorescent light bulbs. Display panel 40 may include a backlit liquid crystal display. Display panel 40 may utilize light emitting diodes to convey information. Display panel 40 may comprise a plurality of different colored lights to convey the information discussed above. Display panel 40 may include a cathode ray tube to display the above-described information. Display panel 40 may include any other apparatus effective to display information pertaining to electrical charging system 28.

An alternate embodiment of vehicle 10 is illustrated in FIG. 4 wherein display panel 40 is mounted proximate a rear windshield 16 and oriented to face a rear quarter panel of vehicle body 12 where docking station 22 is positioned.

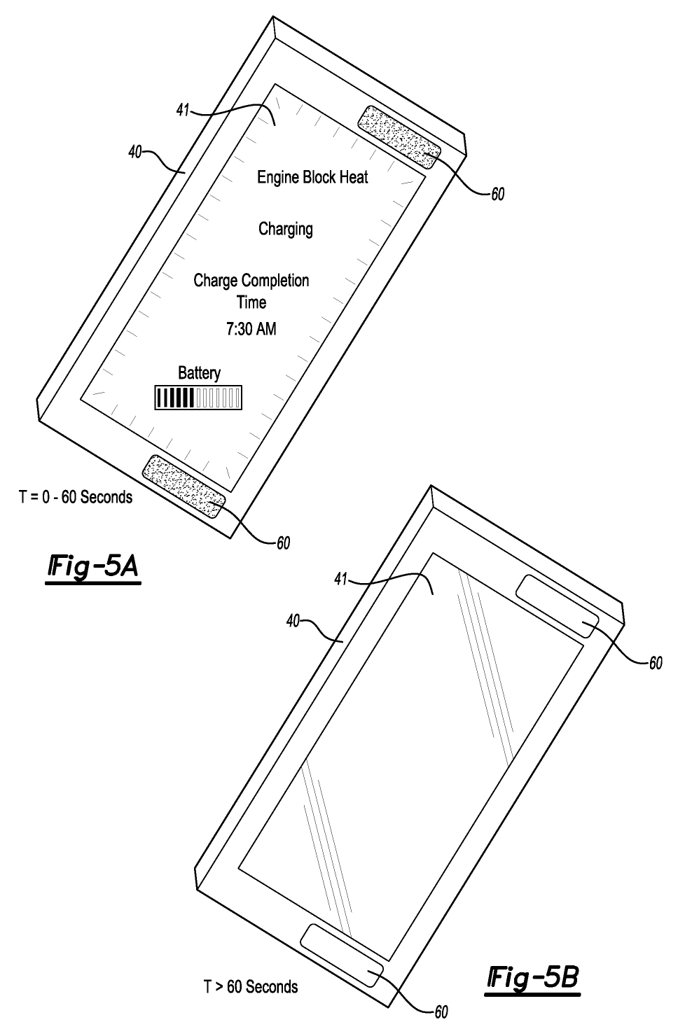

With respect to FIG. 5A, another embodiment of display panel 40 is illustrated. In this embodiment, display panel 40 includes a display window 41 and a liquid crystal display illuminated by incandescent bulbs (not shown). Vehicle 10 may be equipped with a light sensor 58 (see FIG. 1) configured to measure ambient light. The light sensor 58 may be mounted, for example, to the vehicle body 12, and may be further configured to trigger activation of various illumination systems of vehicle 10 in the event that ambient light registers below or above a predetermined level.

In some embodiments of vehicle 10, display panel 40 may be configured to illuminate upon the initiation of a charging cycle. In such embodiments, display panel 40 will illuminate when plug 34 engages docking station 22. In embodiments of vehicle 10 equipped with light sensor 58, the illumination of display panel 40 may occur only when ambient light registers below the predetermined level. In vehicles 10 lacking light sensor 58, display panel 48 may be configured to illuminate regardless of ambient light conditions. In other embodiments, display panel 40 may illuminate automatically when a plug 34 is engaged with docking station 22 and an increased level of illumination may be provided if light sensor 58 determines that ambient light is below the predetermined level.

In other embodiments, display panel 40 may include a timer that provides illumination for a predetermined period of time, for example, sixty seconds, and after which, illumination of display panel 40 ceases (see FIG. 5B). This configuration would permit user 31 a predetermined period of time in which to ascertain information about electric charging system 28 without wasting electric energy throughout the charging sequence as otherwise might occur if display panel 40 lacked such a timer.

In other embodiments, display panel 40 may include speakers 60 configured to emit an audible signal. Display panels 40 equipped with speakers 60 may provide an audible signal in addition to, or instead of, the visual depiction of information related to the status of the electrical charging system 28. For example, when plug 34 is engaged with docking station 22, and rechargeable battery 20 begins to receive an electric charge, display panel 40 may emit a first tone indicative of rechargeable battery 20 receiving a charge. Display panel 40 may be further configured to emit a second distinct tone to indicate that an electric charge is not being received by rechargeable battery 20 after plug 34 has engaged docking station 22. Additionally, display panel 40 may broadcast the second distinct tone if the delivery of electric charge to rechargeable battery 20 is disrupted or otherwise interrupted during a charging cycle.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed:

1. A vehicle comprising:
a vehicle body having an interior portion partially defined by a plurality of windows, the interior portion having a plurality of trim components therein;
an electrical charging system, within the vehicle body, configured to receive an electrical charge from an external source; and
a display panel connected to the electrical charging system to display a status thereof, the display panel being mounted on a trim component in a position such that the information displayed thereby is visible from a portion exterior to the vehicle body.

2. The vehicle of claim 1 wherein the display panel is mounted on a trim component covering a portion of an A-pillar of the vehicle body.

3. The vehicle of claim 1 wherein the display panel is mounted proximate one of the windows.

4. The vehicle of claim 1 wherein the display panel is mounted on a package shelf.

5. The vehicle of claim 4 wherein the display panel is mounted proximate a rear window.

6. The vehicle of claim 1 wherein the display panel is further configured to display information corresponding to a state of charge of a rechargeable battery.

7. The vehicle of claim 1 wherein the display panel is further configured to display information corresponding to an amount of time remaining until charge completion for a rechargeable battery.

8. The vehicle of claim 1 wherein the display panel is further configured to display information indicative of an on-plug status of the electrical charging system.

9. The vehicle of claim 8 wherein the display panel is further configured to display information indicative of a fault experienced by the electrical charging system while on-plug.

10. The vehicle of claim 1 wherein the display panel includes a means for displaying the information indicative of the status of the electrical charging system.

11. The vehicle of claim 1 wherein the display panel is further configured to display the information for a predetermined period of time.

12. The vehicle of claim 11, wherein the vehicle body further includes a door having a door latch, the display panel being further configured to display the information in response to at least one of the electrical charging system beginning to receive an electrical charge or the door latch being actuated.

13. The vehicle of claim 1 wherein the display panel is further configured to emit an audible signal indicative of a status of the electrical charging system.

14. The vehicle of claim 13 wherein the audible signal comprises a first tone indicative of the electrical charging system receiving an electrical charge while the electrical charging system is on-plug.

15. The vehicle of claim 1 wherein the display panel is further configured to receive customer inputs and to display information indicative of a charge mode initiated by the vehicle operator or a connected electrical utility.

16. The vehicle of claim 1 wherein the display panel is further configured to display a plurality of bars corresponding to a state of charge of the rechargeable battery.

17. The vehicle of claim 1, further comprising a light sensor configured to detect when ambient light diminishes below a predetermined level, wherein the display panel is further configured to provide:
a first level of illumination when the ambient light is above the predetermined level, and
a second level of illumination when the ambient light is below the predetermined level.

18. The vehicle of claim 1 wherein the display panel includes an interface portion configured to receive input from a user.

19. A display panel for use with a vehicle having a vehicle body with an interior portion having a plurality of trim components, a plurality of windows supported on the vehicle body and disposed adjacent the interior of the vehicle body, an electrical charging system attached to the vehicle body and having a rechargeable battery, the electrical charging system being configured to receive an electrical charge from at least one of an on-board charger, an external charger or a charging station, the display panel comprising:
a panel configured to display information indicative of a status of the electrical charging system, the panel being mounted on one of the trim components and configured to be disposed in a position such that the information displayed by the display panel is visible from a position exterior to the vehicle body.

20. A vehicle comprising:
a vehicle body having an interior portion, the interior portion having a plurality of trim components;
a plurality of windows supported on the vehicle body and disposed adjacent the interior portion;
an electrical charging system including a rechargeable battery, the electrical charging system being attached to the vehicle body and configured to receive an electrical charge from at least one of an on-board charger, an external charger or a charging station;
an electric motor electrically connected to the rechargeable battery, and configured to propel the vehicle body;
an internal combustion engine mounted on the vehicle body and configured to propel the vehicle body;
a display panel connected to the electrical charging system and mounted on one of the trim components, the display panel being configured to display information indicative of a status of the electrical charging system, the display panel being disposed in a position such that the information displayed by the display panel is visible from a position exterior to the vehicle body.
